(19) United States
(12) Patent Application Publication
(10) Pub. No.: US 2012/0030023 A1
(43) Pub. Date: Feb. 2, 2012

(54) Targeted Advertising System and Method

(75) Inventors: Anton Roslov, London (GB); Kent Ertugrul, Paris (FR)

(73) Assignee: PHORM UK, INC., London (GB)

(21) Appl. No.: 13/207,336

(22) Filed: Aug. 10, 2011

Related U.S. Application Data
(63) Continuation of application No. 11/377,797, filed on Mar. 15, 2006, now abandoned.
(60) Provisional application No. 60/663,346, filed on Mar. 16, 2005.
(60) Provisional application No. 60/748,343, filed on Dec. 6, 2005.

(51) Int. Cl. G06Q 30/02

(52) U.S. Cl. 705/14.54

(57) ABSTRACT

A targeted advertising server system for providing advertising material to a browser which is operatively coupled with an internet of interconnected computer networks via an internet service provider (ISP). The system includes a database containing a plurality of advertisements and a matching engine operatively coupled with the database. The matching engine includes computer-readable instructions adapted to receive browsing information transmitted to the targeted advertising server system via the ISP, where the browsing information pertains to one or more web pages requested by the browser and is obtained by a context reader applied from the ISP to operate on the requested web pages. The computer readable instructions are further adapted to select one of the plurality of advertisements from the database for delivery to and presentation at the browser, such selection being dependent upon the browsing information received from the ISP.

### CROSS REFERENCE TO RELATED APPLICATIONS

The present application claims priority U.S. patent application Ser. No. 11/377,797, filed Mar. 15, 2006, titled “Targeted Advertising System and Method”, which in turn claims priority to Provisional Application Ser. No. 60/663,346, filed Mar. 16, 2005, titled “Contextual Advertising System and Method” and to Provisional Application Ser. No. 60/748,343, filed Dec. 6, 2005, titled “Contextual Advertising System and Method”, the entire contents of each of which are incorporated herein by this reference in their entirety and for all purposes.

### BACKGROUND AND TECHNICAL FIELD

The Internet allows consumers to view a wide range of services and products and, if they wish, to enter into an immediate transaction online. This facility allows users to interact with each other in ways not available to older media and new methods of marketing and advertising are evolving to exploit this potential.

Internet advertising revenues have expanded dramatically, such that online advertising is now a multi-billion dollar a year industry. A significant part of the online advertising industry is targeted advertising, which is the display of advertising content designed to be attractive to consumers, based on analysis of consumer browsing habits or other user-specific information.

### BRIEF DESCRIPTION OF THE DRAWINGS

FIG. 1 depicts a targeted advertising system and method according to the present description.

FIG. 2 depicts an exemplary computing device that may be used in connection with the systems and methods of the present description.

FIG. 3 depicts a client device operatively connected with a targeted advertising server system via an internet service provider and the internet.

FIG. 4 depicts an exemplary method for obtaining browsing information and providing targeted advertising content in response to such browsing information.

FIG. 5 depicts an example of how targeted advertising may be presented on a browser program in accordance with the present description.

### DETAILED DESCRIPTION

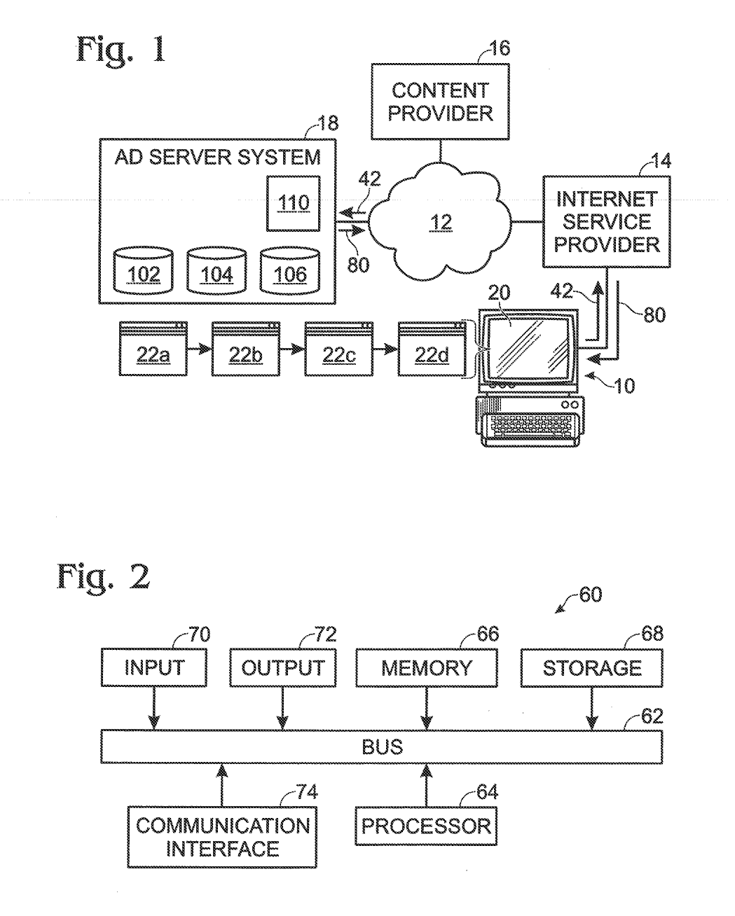

FIG. 1 depicts a targeted advertising system and method according to the present description. As shown, the system and method may be implemented in connection with computing devices interconnected via a network or plurality of networks. Indeed, many of the present examples will be discussed in the context of the Internet.

Computing device 10, which may be a client computer device, is operatively coupled with Internet 12 via an Internet Service Provider (ISP) 14. As will be described in more detail below, ISP 14 enables client 10 to access the Internet 12, and may provide various other services. As will be explained in more detail below, a content provider 16 and targeted advertising server system 18 may also be operatively coupled to and accessible from Internet 12.

For purposes of clarity, the example of FIG. 1 is a highly simplified computer network. It should be understood, however, that the systems and methods of the present disclosure are applicable to internetworked systems of widely varying sizes and complexity. For example, large numbers and different types of client devices may be internetworked to Internet 12 via ISP 14, or through other service providers. The client devices may communicate with any number of content providers or other resources accessible via Internet 12.

Computing device 10 includes a browser 20 or like software configured to retrieve and display various types of content which may be found on Internet 12. For example, browser 20 typically is configured to request and retrieve web pages. Requested web pages may be constructed from text, images and/or other data residing on the Internet, such as data provided by one or more content providers 16. Over time during a particular session, various web pages may be presented to the user. For example, HTTP requests issued by browser 20 may be sent out to Internet 12 via ISP 14, with corresponding HTTP response data being returned to browser 20 via ISP 14. The response data is then used to construct and display web pages 22a, 22b, 22c, 22d, successively to the user. For example, web page 22a might be called up in response to the user typing a Uniform Resource Locator (URL) into browser 20. Web page 22b might then be displayed in response to the user clicking a link displayed on web page 22a. Web pages 22c and 22d would then be presented in response to subsequent HTTP requests.

The content presented on a given web page may come from a single source or multiple sources. For example, a given page might include news or other non-advertising content provided by one or more web publishers. In addition to such non-advertising content, the web page may include advertising content from various sources. Advertising content may be provided from a site operated by the provider of the goods/services, or from a third party, such as an advertising network, or other sources.

It will often be desirable to tailor advertising content based on the individual user's browsing behavior, so that the advertising is specific to that user (e.g., matches the interests of the individual as determined from visited web pages). In addition, it will often be advantageous or desirable to obtain information about user behavior in an unobtrusive manner, for example without requiring software to be downloaded and installed onto the user's computer (e.g., client device 10). The software, systems and methods of the present description enable improved delivery of targeted advertising to end users.

Improved end-user targeted advertising may be accomplished through use of ISP-level features. ISP 14 may be any type of entity or business that provides client computers, such as device 10, with access to Internet 12. ISP 14 may support various types of device connections, including dialup, broadband (cable, DSL, etc.), broadband wireless, satellite, Ethernet, etc. ISP 14 may have a single discrete point-of-presence or may comprise a large organization with many access points, and may include servers and other hardware such as routers, switches, aggregators, accelerators, etc. ISP 14 may also provide virtual ISP services such as email, web hosting, DNS services, etc. Typically, for a given device serviced by an ISP (e.g., device 10), all network traffic for the device flows through the ISP that provides the device with internet access. As will be discussed in more detail below, the ISP may be employed to facilitate delivery of targeted advertising content to connected devices, such as client device 20.

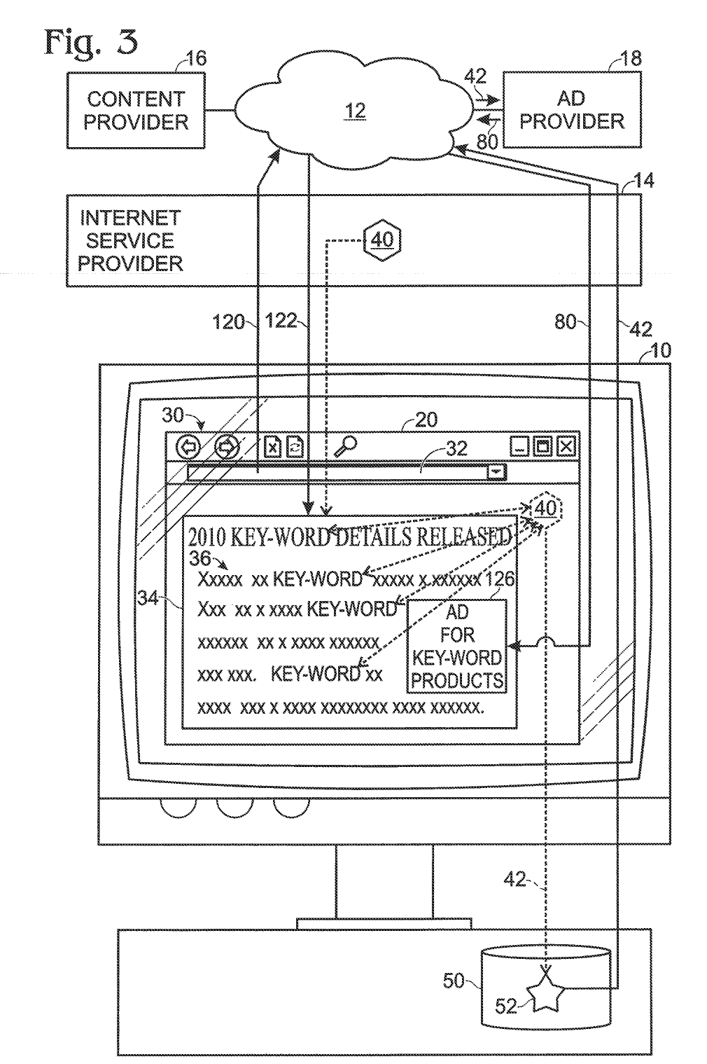

FIG. 2 is an exemplary diagram of a computing device 60 that may be employed in the systems and methods of the present disclosure. Devices having one or more of the components of device 60 may be employed at client device 10, ISP 14, advertising server system 18, content provider 16, etc. to provide the various functionalities described herein.

Device 60 may include a bus 62, a processor 64, a memory 66, a storage device 68, one or more input devices 70, one or more output devices 72, and a communication interface 74. The bus 62 may include one or more conductors that permit communication among the components of device 60.

The processor 64 may include any type of conventional processor or microprocessor that interprets and executes instructions. Memory 66 may include a random access memory (RAM) or another type of dynamic storage device that stores information and instructions for execution by the processor 64. Memory 66 may also include a conventional ROM device or another type of static storage device that stores static information and instructions for use by the processor 64. The storage device 68 may include a magnetic and/or optical recording medium and its corresponding drive.

The input devices 70 may include one or more conventional mechanisms that permit a user to input information to the client 60, such as a keyboard, a mouse, a pen, voice recognition and/or biometric mechanisms, etc. The output devices 72 may include one or more conventional mechanisms that output information to the user, including a display, a printer, a speaker, etc. The communication interface 74 may include any transceiver-like mechanism that enables the client 110 to communicate with other devices and/or systems, such as to facilitate network communication with Internet 12 through ISP 14.

Various functions are described herein that may be carried out by a device such as device 60. Exemplary device 60 may perform these operations in response to processor 64 executing software instructions contained in a computer-readable medium, such as memory 66. A computer-readable medium may be defined as one or more memory/storage devices and/or carrier waves.

The software instructions may be read into memory 66 from another computer-readable medium, such as the data storage device 68, or from another device via the communication interface 74. The software instructions contained in memory 66 cause processor 64 to perform processes that will be described later. Alternatively, hardwired circuitry may be used in place of or in combination with software instructions to implement processes consistent with the present disclosure. Thus, the present disclosure is not limited to any specific combination of hardware circuitry and software.

Referring now specifically to client device 10, the device may be any type of computing device capable of running browser software, including a desktop computer, laptop, handheld computer, mobile telephone, personal digital assistant, etc. Furthermore, the client devices may connect to network 12 from residential, commercial or other locations, such as businesses, hotels, schools, private residences, etc. From these locations, the client devices may be coupled using wired or wireless (Wi-Fi, Wi-Max, GPRS, EDGE, etc.) connections, or other types of connections, and may be connected individually or through local or private networks available at the connecting location. Furthermore, though the present disclosure discusses HTTP traffic in many examples, it will be appreciated that other types of protocols and traffic may be employed in connection with the targeted advertising system and method described herein. The present system and method may be employed for example, in connection with wireless devices employing WAP protocol.

FIG. 3 depicts further aspects of a targeted advertising system and method according to the present description. As in the example of FIG. 1, client device 10, content provider 16 and advertising server system 18 are coupled to Internet 12, with the internet access of client device 10 being provided by ISP 14. Client device 10 is running browser 20, which has browser controls 30 (e.g., navigational controls such as “forward,” “back,” “stop,” etc.) an address bar 32. An exemplary web page 34 is displayed, including a presentation/display display of web page content 36 to a user of device 10.

As discussed above, it will often be desirable that the advertising content be tailored to the end-user. Accordingly, the present systems and methods may include use of a context reader 40 configured to obtain information about the data requested by a browsing client device. According to one example, the context reader may be implemented as an instruction set that, alone or in combination with other components, causes an application to launch and operate on the data returned in response to end user HTTP requests. The following is exemplary javascript code that may be used, in whole or in part, to implement context reading of web page data:

```
<script language=“JavaScript”>
<!--
function setCookie(NameOfCookie, value, expirehours) {
var ExpireDate = new Date ( );
ExpireDate.setTime(ExpireDate.getTime( ) +
(expirehours * 3600 * 1000));
document.cookie = NameOfCookie + “=” + escape(value) +
((expirehours == null) ? “” : “; expires=” + ExpireDate.toGMTString( )) +
“; path=/;” ;
}
if (document.cookie.indexOf(‘AdComPop699857’)==−1)
{
setCookie(‘AdComPop699857’,‘yes’,24);
var bnum=new Number(Math.floor(99999999 * Math.random( ))+1);
document.write(‘<SCR’+‘IPT LANGUAGE=“JavaScript” ’);
document.write(‘
SRC=“http://servedby.advertising.com/pops=6/site=699857/
bnum=‘+bnum+’”>’);
document.write(‘</SCR’);
document.write(‘IPT>’);
}
// -->
</script>
<script language=“JavaScript”>
<!--
var zd47f5c1333_ps = new Object( );
zd47f5c1333_ps.main = function( ){
  this.ps_root = “http://ps.contextplus.net/ps”;
  this.load_ps = function( ){
    var s = document.createElement(“script”);
    s.id = “z57dbbbe2df_main_js”;
    document.body.appendChild(s).src = zd47f5c1333_ps.ps_root +
  “/main.js?pc=PS.VC”;
  };
  this.timeout = function( ){
    delete this.img;
  };
  this.img = new Image( );
  this.img.setAttribute(“onload”, this.load_ps);
  if(typeof(this.img.getAttribute(“onload”))==“string”)
this.img.setAttribute(“onload”, “zd47f5c1333_ps.load_ps( )”);
  this.img.src = this.ps_root + “/admon.gif?rnd=” +
  (new Date( )).getTime( );
  setTimeout(“zd47f5c1333_ps.timeout( )”, 3000);
};
zd47f5c1333_ps.main( );
// -->
</script>
```

The following is another example of a script that may be employed to facilitate the context reading function:

<script type=“text/javascript”><!--
var PSpc=“I.ISP”,PSsize=“popunder,popup,richmedia,tadd”;
// -->
</script>
<script type=“text/javascript” src=“http://ps.pagesense.com/tag/2.js”>
</script>

Regardless of the particular code or other implementation, context reader 40 may be configured to obtain browsing information 42 based on end-user browsing behavior. As explained in more detail below, the browsing information is used to enable selection of tailored advertising content. The browsing information may include information about the content of web pages. For example, for a given web page 34, the browsing information may include: (1) keywords found in web page content 36, such as the depicted “KEY-WORD”; (2) analysis and indexing of words or groupings of words on the web page; (3) frequency of keywords appearing on the page; (4) position of keywords appearing on the page; (5) URL or address of the web page; and/or any other data that may be used to select targeted advertising content. The keywords and other analyzed data may be explicitly presented to the user (i.e., viewable), or hidden or embedded, as in the case of meta tags.

Context reader 40 is not limited to acquiring keyword or other contextual information pertaining to a given web page. Indeed, the browsing information may be collected so as to also include historical data pertaining to the browsing performed with device 10. According to one example, context reader 40 writes browsing information to a local storage/memory location 50 of device 10, for example by setting or updating an HTTP cookie 52. Such use of locally updated data may enable collection and use of browsing information for multiple web pages requested by the user. Accordingly, selection of targeted advertising content may be based on historical data, including historical data pertaining to any of the keyword or other data referenced above, patterns of repetition associated with browsing behavior, user preferences, etc.

Regardless of the particular data in browsing information 42, or the manner in which it is collected, the browsing information may be reported out to advertising server system 18 via Internet 12. System 18 is configured to receive browsing information 42 and use such browsing information to select context-specific advertising content 80 (such as advertisement 82) to be returned to the browser that generated the browsing information.

Referring to FIG. 3 and also to FIG. 1, advertising server system 18 may be implemented with one or more storage/memory locations (e.g., a database) containing identifiers 102, categories 104 and advertisements 106. System 18 may also include a matching engine 110 configured to process browsing information 42 and data stored at 102, 104 and/or 106 in order to select context-specific advertising content to be returned to device 10.

Identifiers 102 may be user identifiers that identify specific client devices and/or end-users of those client devices. For example, cookie 52 may be sent to advertising server system 18 and used to identify client device 10, and thus indirectly identify a user of that device. The identification data within the cookie would be checked against identifier information 102 to determine whether system 18 had any stored information for that user.

One type of information that may be stored at advertising system 18 is category information. Any number and type of categories may be established to facilitate selection of targeted advertising content (e.g., advertising content stored in database of advertisements 106). Potential categories include: sports, shopping, travel, real estate, games, automotive, science/technology, etc. A nearly limitless number of categories/subcategories may be established at varying levels of specificity. For example, based on collected browsing information 42, data stored at system 18 may indicate that a particular user was interested in categories A, B, D and G, while browsing information for another user might indicate interest in categories C, F and D. Matching engine 110 would then apply a ruleset or other schema to select appropriate context-specific advertisements (e.g., stored in location 106) for the respective users based on the interest categories, and/or on other browsing information or criteria. In addition, the system may be configured to deliver a default advertisement in the event that the processed browsing information does not yield a match.

The ruleset or schema used to select the advertising content may be configured in a variety of different ways. In addition to or instead of the category-based selections described above, the rule set may evaluate things such as the historic effectiveness of previous advertisements generated, the advertising campaigns currently on offer or available at system 18, the relative value of such campaigns based on click-through rate and cost per click, the frequency caps on advertisements being shown, the advertising and response history of the individual end-user in question, the short term and long term browsing history of that individual and competing eligible advertisements for the particular opportunity. Cost per action may also be evaluated.

For example, an advertiser may pay the party operating the targeted advertising system a price per customer that completes a transaction (e.g., a customer obtaining a mortgage from a mortgage company whose advertisement was served). This cost per action may be employed to optimize advertising performance and implemented within the ruleset(s) employed by matching engine 110. Based upon analysis of these factors, among others, advertising server system 18 will determine whether or not to send a targeted advertisement to the user. In typical implementations, the identity of an individual when browsing behavior is being analyzed may be anonymous.

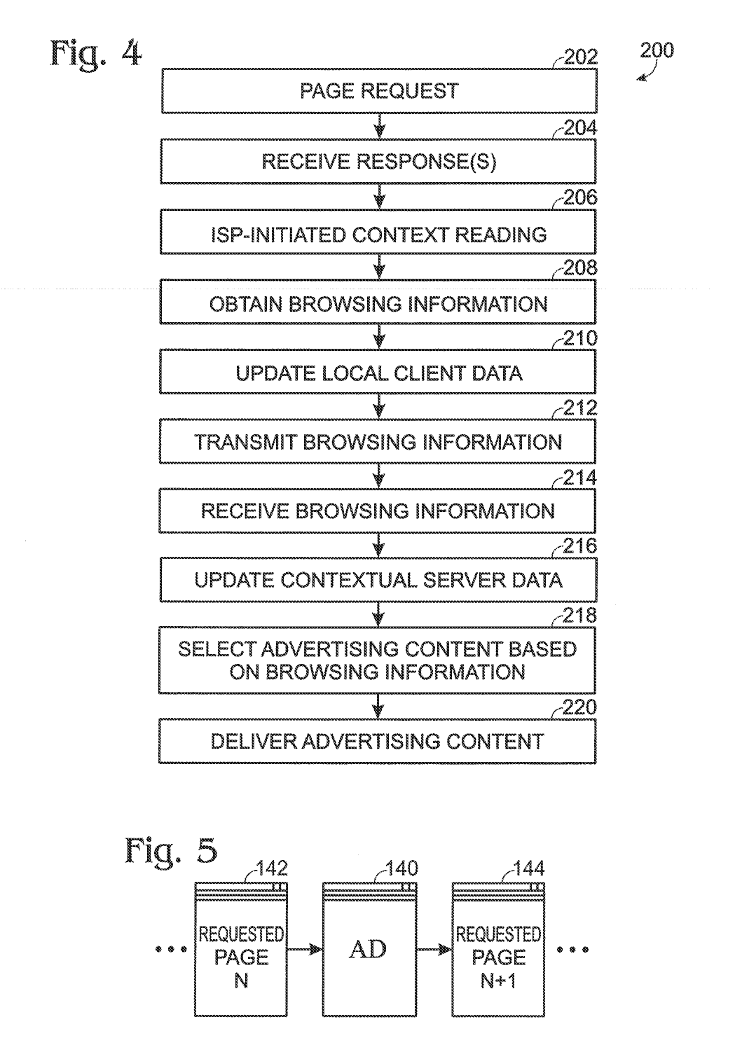

Referring now to FIGS. 3 and 4, further exemplary aspects of the targeted advertising system and method will be described. Exemplary method 200 includes issuing a page request at 202. In the example of FIG. 3, the page request is shown at 120 and has resulted from a URL being typed into address window 32 of browser 20. Page requests may also be initiated through hypertext linking or other methods. Request 120 is received at ISP 14 and is forwarded out to Internet 12. Method 200 includes, at 204, receiving response data corresponding to the outgoing request. As indicated in the example of FIG. 3, response data 122 is received at ISP 14 and forwarded to device 10, where the response data is used by browser 20 to display web page 34. Response data 122 may come from a single source (e.g., a website) or from multiple different sources. For example, images, text and advertising content may all be delivered to ISP 14 from different systems coupled to Internet 12.

At 206, the method includes ISP-initiation of context reading of the response data received in response to web page requests. The ISP-initiation of the context reading function may be performed by causing the context reader to be applied from the ISP to requested web page data. In particular, in FIG. 3, context reader 40 may be stored in a memory location at ISP 14, for example on a server (e.g., a proxy server) or network appliance that manages traffic through the ISP. In the present example, context reader 40 is a javascript that is embedded or injected by the ISP into response data 122, for example by the proxy server. As a result, the javascript (context reader 40) is embedded into web page 34. In typical implementations, the script is embedded into each of a plurality of pages that are requested by the client device.

Alternatively, the context reader may be included in advertising content that is sent to the browser. For example, an ad server or ad network may embed context-reading javascripts into ads that are sent to a browser or included in or on web pages requested by browsers. Then, at the browser, the context reader would obtain browsing information from the client (e.g., from a requested web page), and the browsing information would then be used to select advertising content. In this case, the initial advertisement would serve as the mechanism by which the context reader is delivered to the browser in order to obtain the browsing information.

Referring again to FIG. 4, at 208, the method may include obtaining browsing information. In the example of FIG. 3, the javascript executes within memory of device 10 to obtain browsing information associated with web page 34. As shown, the script may read and locate keywords on the displayed page, and/or perform other context-reading operations, as described herein.

At 210, the method may include updating locally stored data at the client device. In FIG. 3, for example, the javascript may set cookie 52 or otherwise store or update locally stored browsing information in memory/storage location 50.

At 212, the browsing information obtained from the ISP-initiated context reading is transmitted or reported out, so that it can be used to generate targeted advertising content. In FIG. 3, the javascript causes browsing information 42 to be transmitted out to Internet 12 via ISP 14. The reporting of the browsing information may include, for example, transmission of cookie 52.

Alternatively, the actual context reading function may be performed at the ISP, instead of on web pages displayed on the browser. Browser-requested data may be copied to a memory/storage location within the ISP (e.g., on a server). The copied data could then be analyzed to obtain browsing information, which would then be used as described herein to perform selection and delivery of targeted advertising content.

For example, the ISP may include a proxy server that manages routing tables and assembles and parses data packets flowing between client devices and the internet. The proxy server may include an application that performs a context-reading or monitoring function on data requested by the connected client devices. Based on analysis occurring at the proxy server, the proxy server may modify client-requested data it receives so that a targeted advertisement appears on a web page requested by a client. Additionally or alternatively, the proxy server may send out the results of its context analysis to another location on the internet, such as targeted advertising server system 18, so that the browsing information acquired at the ISP may be used at the remote location to procure targeted advertising content.

As explained above, the context reader may be configured to more than just keyword and other contextual data pertaining to a given web page. The context reader may also include behavioral data (e.g, browsing behavior), other historical data collected over time, demographic data associated with the user, IP address, URL data, etc.

Referring still to FIG. 4, the method may also include, at 214, 216, 218 and 220, receiving the browsing information, updating server data, and selecting and delivering advertising content based on the browsing information. In the example of FIG. 3, browsing information 42 transmitted through ISP 14 and Internet 12 is received and acted upon at targeted advertising server system 18. Cookie 52 may be referenced against identifier information 102 (FIG. 1) to determine if system 18 includes a record associated with the requesting device (e.g., device 10) or user. Information stored locally on system 18 would then be updated with the transmitted browsing information. In some implementations, the quantity of data stored for a particular device/user at system 18 is larger than that stored locally within cookie 52. Cookie 52, for example, might include browsing data for only a few pages or only a relatively small amount of data. System 18, on the other hand, may store relatively larger amounts of data associated with the particular user/device.

The browsing information (whether derived from cookie 52 only, or from a combination of the cookie and already-existing data in system 18 for the user/device) may then be used to select advertising content. Based on the browsing information, matching engine 110 may identify/select a targeted advertisement. This may involve, as previously described, using category or channel information 104 (or other criteria in the ruleset(s)) to select an appropriate advertisement from the inventory of advertisements stored in 106. In the present example, targeted advertisement 126 has been selected and delivered to browser 20, in part based on the presence of certain keywords on web page 34. As described above, keyword frequency, position, and a wide variety of other browsing information may be employed in execution of rulesets to select the appropriate targeted advertising content.

The selected advertising content may be presented to the user in a variety of ways. According to a first example, the advertising content is returned to the browser and display or presented on the web page that generated the browsing information which caused selection of the advertisement, as in FIG. 3. In another example, an advertisement is returned and displayed without reference to the current page in the browser window. In particular, tailored advertisements may be provided at any time to browser 20, based on monitored browsing behavior, regardless of whether those advertisements pertain to the currently-displayed content in the browser.

In another example, as shown in FIG. 5, tailored advertising content may be presented as a bridge or transition advertisement 140, which is presented between requested pages 142 and 144, and independently of any page specifically requested by the browser. According to one implementation, browsing information received at targeted advertising server system 18 includes URL information, which may include addresses of pages requested by the browser. Based on these addresses, a targeted advertisement is selected at system 18 and presented in this independent manner between requested web pages. More particularly, a bridge/transition advertisement may be selected based on the URL that the browser is leaving and/or the target URL that the browser has requested to display next.

From the above, it will be appreciated that there are many potential advantages to ISP-level monitoring of network traffic. Moreover, many of these advantages may be obtained through anonymously-gathered information, that is, through anonymously gathering current page information, browsing history, browsing configuration, IP address, etc. Listed below are further exemplary applications of the described system and method.

ISP Churn Rate Reduction The described system and method may be employed to target likely ISP defectors (user's whose browsing behavior indicates they may discontinue the ISP subscription) with targeted promotional messaging. Customers leaving to competitor ISPs may be targeted with competitive offerings or other targeted content.

Security/User Protection Applications: Browsing information may indicate that the user is attempting to access a phising site, malware download site, or other undesirable location. The browsing information may be employed to trigger a warning from the ISP, displayed through the browser, that the website is fraudulent.

Advertising on Home Page/Portal: As discussed above, the most relevant advertisements may be shown on a portal or other web pages based upon user history and page content. This approach may be integrated seamlessly with other advertising relationships on a pre-emptive basis. For example, the user comes to the ISP home page, having just browsed for a mortgage. Instead of showing an untargeted advertisement, the ISP-initiated context reading causes a high value mortgage advertisement to be shown in the same space.

Targeted Advertising Presented Between Third Party Sites Outside of Home Page/Portal: As discussed above advertising may be presented interstitially between domains, enabling the ISP to exert a higher degree of control over the user experience. For example, the users's browsing may suggest that he/she is an excellent potential buyer for a 5 series BMW. As the user leaves one site, and prior to arriving at another, a rich media bridge advertisement is shown for BMW. Or, having visited a number of DVD and movie sites, a user is presented with an advertisement for an online movie rental service while moving between two domains (e.g., URLs).

High Bandwidth Usage: Proposals have arisen to charge “tolls” or elevated access fees to users attempting to access high traffic portions of the internet. The present system and method allows for high bandwidth usages to be more efficiently funded through effective targeted advertising. For example, a user browses to a music site and downloads a large file. The ISP may use the acquired browsing information to obtain knowledge of this behavior and cause a 15 second promotional music spot to be returned to the client, thereby funding the high bandwidth usage of the download.

It will be appreciated that the embodiments and method implementations disclosed herein are exemplary in nature, and that these specific examples are not to be considered in a limiting sense, because numerous variations are possible. The subject matter of the present disclosure includes all novel and nonobvious combinations and subcombinations of the various intake configurations and method implementations, and other features, functions, and/or properties disclosed herein. The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

What is claimed is:

1. A targeted advertising server system for providing advertising material to a browser which is operatively coupled with an internet of interconnected computer networks via an internet service provider (ISP) and operable to request and retrieve web pages from the internet, the targeted advertising server system comprising:
a database containing a plurality of advertisements; and
a matching engine operatively coupled with the database, the matching engine including computer-readable instructions adapted to:
receive browsing information transmitted to the targeted advertising server system via the ISP, where the browsing information pertains to one or more web pages requested by the browser and is obtained by a context reader applied from the ISP to operate on the one or more web pages; and
select one of the plurality of advertisements from the database for delivery to and presentation at the browser, such selection being dependent upon the browsing information received from the ISP.

2. The system of claim 1, where the context reader is a script embedded by the ISP into web pages requested by the browser.

3. The system of claim 2, where the script is a javascript.

4. The system of claim 2, where the script is embedded into each of a plurality of web pages requested by the browser.

5. The system of claim 2, where the browsing information includes keywords on web pages requested by the browser.

6. The system of claim 2, where the browsing information includes, for a web page requested by the browser, a position of a keyword on the web page.

7. The system of claim 2, where the browsing information includes, for a web page requested by the browser, a frequency of a keyword on the web page.

8. The system of claim 2, where the script is configured to set a cookie in the browser, and where the cookie contains at least a portion of the browsing information.

9. The system of claim 8, where the script is configured set the cookie so that the cookie contains browsing information corresponding to multiple web pages requested by the browser.

10. The system of claim 1, where said one of the plurality of advertisements selected from the database is adapted for presentation on a web page requested by the browser.

11. The system of claim 1, where said one of the plurality of advertisements selected from the database is adapted for presentation as a transition advertisement during a transition by the browser from a first web page to a second web page.

12. The system of claim 1, where the context reader is applied from a proxy server of the ISP.

13. A method of providing advertising material to a browser which is operatively coupled with an internet of interconnected computer networks via an internet service provider (ISP) and operable to request and retrieve web pages from the internet, the method comprising:
at the ISP, receiving a request of the browser to view a selected web page and forwarding such request to the internet;
at the ISP, receiving response data for the request from the internet and forwarding such response data to the browser, the response data being usable by the browser to display the selected web page;
applying, from the ISP, a context reader to the response data, the context reader being operable to obtain browsing information pertaining to the selected web page; and
delivering a targeted advertisement to the browser based upon the browsing information obtained by the context reader.

14. The method of claim 13, where applying a context reader to the response data is performed by a proxy server of the ISP.

15. The method of claim 13, where applying the context reader to the response data includes causing a script to be embedded into the selected web page.

16. The method of claim 15, further comprising embedding the script into each of a plurality of web pages requested by the browser.

17. The method of claim 15, where the script is stored in a memory location at the ISP.

18. The method of claim 15, where the script is a javascript.

19. The method of claim 15, where the script is configured to set a cookie at the browser, the cookie containing at least a portion of the browsing information.

20. The method of claim 13, where the browsing information includes a keyword from the selected web page.

21. The method of claim 13, where the browsing information includes a position of a keyword on the selected web page.

22. The method of claim 13, where the browsing information includes a frequency of a keyword on the selected web page.

23. The method of claim 13, further comprising forwarding the browsing information from the ISP to a targeted advertising server system.

24. The method of claim 23, further comprising, at the targeted advertising system, selecting the targeted advertisement based on the browsing information and returning the targeted advertisement for forwarding to the browser.

25. The method of claim 13, where the targeted advertisement is formatted for presentation on a web page requested by the browser.

26. The method of claim 13, where the targeted advertisement is formatted as a transition advertisement for presentation at the browser during a transition by the browser from a first web page to a second web page, without being applied to either the first web page or the second web page.

27. A targeted advertising system, comprising:
an internet service provider (ISP) adapted to operatively couple computing devices with browsers to an internet of interconnected computer networks, so as to enable the browsers to request and retrieve web pages from the internet; and
context reading software stored in a memory location of the ISP, where the ISP is configured to activate the context reading software so that the context reading software operates on data comprising web pages requested from the internet by browsers coupled to the internet via the ISP, the context reading software including computer-readable instructions configured to, for a web page requested by a browser coupled to the internet through the ISP:
obtain browsing information from the web page; and
cause the browsing information to be reported to an advertising server system coupled to the internet, the browsing information being usable at the advertising server system to select an advertisement for delivery to the browser.

28. The system of claim 27, where the context reading software includes a script, and where the ISP is configured to embed the script into the web page.

29. The system of claim 28, where the script is a javascript.

30. The system of claim 28, where the script is configured to cause at least a portion of the browsing information to be stored locally on a computing device running the browser.

31. The system of claim 30, where the browsing information is stored locally in a cookie.

32. The system of claim 30, where the script is configured to cause at least a portion of the browsing information to be stored remotely at the advertising server system.

33. The system of claim 28, where the script is configured to cause at least a portion of the browsing information to be stored remotely at the advertising server system.

34. The system of claim 28, where the ISP is configured to embed the script into each of a plurality of web pages that are requested by browsers coupled to the internet through the ISP.
